(19) United States
(12) Patent Application Publication
(10) Pub. No.: US 2013/0133430 A1
(43) Pub. Date: May 30, 2013

(54) POWER CIRCUIT AND PORTABLE ULTRASOUND DETECTING DEVICE COMPRISING SAME

(71) Applicant: GE Medical Systems Global Technology Compan, Waukesha, WI (US)

(72) Inventor: Feng WU, JiangSu (CN)

(73) Assignee: GE MEDICAL SYSTEMS GLOBAL TECHNOLOGY COMPANY LLC, Waukesha, WI (US)

(21) Appl. No.: 13/690,584

(22) Filed: Nov. 30, 2012

(30) Foreign Application Priority Data
Nov. 30, 2011 (CN) 201110405491.4

(51) Int. Cl. G05F 5/00

(52) U.S. Cl. CPC G05F 5/00
USPC 73/649; 323/299; 307/72

(57) ABSTRACT

A power circuit is provided. The power circuit comprises an input terminal configured to receive a DC input, a DC-DC converting module configured to convert the DC input received at the input terminal into one or more DC outputs at predefined ratings, and a parameter configuring module configured to configure parameters of the DC-DC converting module to match with the DC input received at the input terminal based on different DC inputs. The DC-DC converting module is further configured to operate at the parameters configured by the parameter configuring module, and an output terminal configured to output the one or more converted DC output.

### BACKGROUND OF THE INVENTION

Embodiments of the present invention relate to a power circuit and a portable ultrasound detecting device comprising the power circuit.

A portable ultrasound detecting device needs more and more channels and higher and higher performance. This requires a high performance power circuit which can meet the requirements for high efficiency and ultra low noise, especially the low noise high voltage supply circuit and the power supply for the continuous wave Doppler which has critical requirements for noise.

The portable ultrasound detecting device has two types of power supplies, one from an AC (alternating current) adapter (namely an AC-DC converter) (input voltage being about 20 volts) and the other from a battery (input voltage being about 9-12 volts). The power circuit of the portable ultrasound detecting device comprises a DC-DC converting module which converts a DC input from the AC adapter or battery into various DC voltages for use by the ultrasound detecting device.

In an existing power circuit of the portable ultrasound detecting device, the architecture of the DC-DC (direct current-direct current) converting module uses a fixed design for different power supplies (i.e., an AC adapter outputting 20V DC and a battery outputting 12V DC). As shown in FIG. 1, the resistance and/or capacitance value of the peripheral components (the components in the dotted frames) of the DC-DC converting modules are fixed and cannot vary with different inputs. In this condition, the design for the DC-DC converting module is limited. That is, the design is either based on a power supply with 20V DC output or based on a power supply with 9-12V DC output. This has great impact on the stability, efficiency and noise performances of the DC-DC circuit, and will especially give rise to a noise issue under some high sensitivity modes, such as the noise issue of continuous wave Doppler images in the case of different input sources of the power supply.

At present, some designs use an additional circuit before the DC-DC conversion to stabilize the input DC voltage to a fixed value such as about 16V. However, it will cause about 20-30% total power consumption constant loss and will result in issues of heat dissipation and stability of the system.

### BRIEF DESCRIPTION OF THE INVENTION

According to an embodiment of the present invention, a power circuit is provided. The power circuit comprises an input terminal configured to receive a DC input, a DC-DC converting module configured to convert the DC input received at the input terminal into one or more DC outputs at predefined ratings, and a parameter configuring module configured to configure parameters of the DC-DC converting module to match with the DC input received at the input terminal based on different DC inputs. The DC-DC converting module is further configured to operate at the parameters configured by the parameter configuring module, and an output terminal configured to output the one or more converted DC output.

According to another embodiment of the present invention, a portable ultrasound detecting device comprising a power circuit. The power circuit comprises an input terminal configured to receive a DC input, a DC-DC converting module configured to convert the DC input received at the input terminal into one or more DC outputs at predefined ratings, and a parameter configuring module configured to configure parameters of the DC-DC converting module to match with the DC input received at the input terminal based on different DC inputs. The DC-DC converting module is further configured to operate at the parameters configured by the parameter configuring module, and an output terminal configured to output the one or more converted DC output. The portable ultrasound detecting device operates with the one or more DC output from the output terminal of the power circuit.

### BRIEF DESCRIPTION OF THE DRAWINGS

The various features of the embodiments of the present invention will be more easily understood with the detailed description in connection with the figures below. The same or similar elements are represented with the same reference numerals throughout the figures, in which:

FIG. 1 illustrates a diagram of a power circuit with fixed peripheral components in the prior art; and

FIG. 2 illustrates a schematic block diagram of a power circuit according to an embodiment of the present invention.

### DETAILED DESCRIPTION OF THE INVENTION

The embodiments of the present invention are described in detail below with reference to the figures that constitute a part of the description, wherein the particular embodiments that can implement the present invention are illustrated by way of example. It shall be understood that other embodiments can also be utilized, or that structural or logical amendments can be made without departing from the scope of the present invention. Therefore, the detailed description below shall not be construed in a restrictive sense.

FIG. 2 illustrates a schematic block diagram of a power circuit according to an embodiment of the present invention. As shown in FIG. 2, the power circuit comprises a DC-DC converting module 1, an input terminal 2 and an output terminal 3. The input terminal 2 is configured to receive a DC input a source such as a battery or an AC adapter. The DC-DC converting module 1 is configured to convert the received DC input into one or more DC outputs at predefined rating(s) (for example, a plurality of DC outputs having different voltages). The output terminal 3 is configured to output the converted DC outputs. The power circuit further comprises a parameter configuring module 4 for configuring the parameters of the DC-DC converting module 1 to match with the DC input received at the input terminal 2 based on different DC inputs received at the input terminal 2. For example, if the DC input is from the AC adapter and has a voltage level of 20 volts, then the parameter configuring module 4 configures the parameters of the DC-DC converting module 1 to match with this voltage level. Likewise, if the DC input is from the battery and has a voltage level of 12 volts, then the parameter configuring module 4 configures the parameters of the DC-DC converting module 1 to match with this voltage level. It shall be understood that although the voltage level is exemplified here for explanation, persons skilled in the art will realize that the parameters of the DC-DC converting module 1 can also be configured according to current or power level of the DC input.

In this way, the DC-DC converting module 1 operates at the parameters matching with respective DC input, and thereby can efficiently convert the DC input.

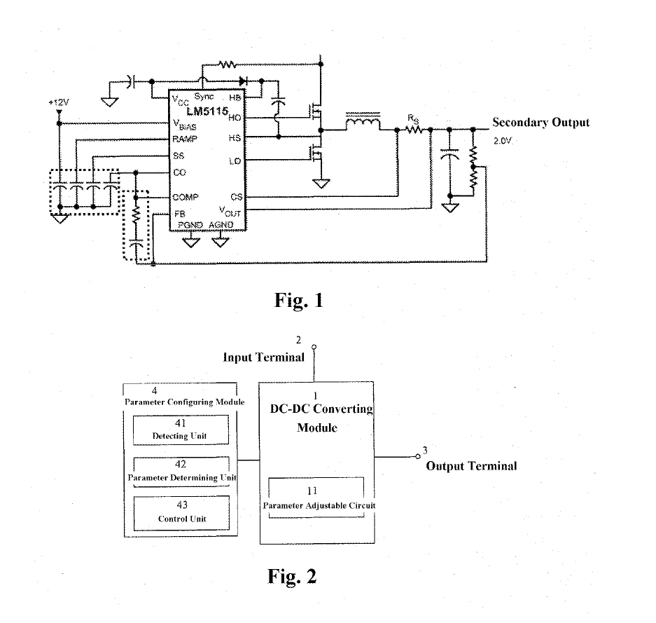

As previously discussed, the parameters of the DC-DC module in the prior art (e.g., the values of the peripheral resistor and/or capacitor components) are fixed and non-adjustable. In one embodiment, to make the parameter adjustable, the DC-DC converting module 1 has a parameter adjustable circuit 11 comprising a resistor with a variable resistance value and/or a capacitor with a variable capacitance value, as peripheral components, connected to the DC-DC converting module 1. The parameter adjustable circuit 11 can be an alternative to or addition to the peripheral components in the dotted frames shown in FIG. 1 to make the parameters of the DC-DC converting module 1 adjustable. The parameter configuring module 4 configures the parameters of the DC-DC converting module 1 to match with the DC input received at the input terminal 2 by adjusting the resistance value and/or capacitance value of the parameter adjustable circuit 11.

In an embodiment of the present invention, the parameter adjustable circuit 11 uses a change-over switch and a set of resistors with different resistance values and/or a set of capacitors with different capacitance values to implement a resistor with a variable resistance value and/or a capacitor with a variable capacitance value, wherein the parameter configuring module 4 selects a proper resistance value and/or capacitance value by controlling the change-over switch, so as to configure the parameters of the DC-DC converting module 1. For example, the parameter adjustable circuit 11 has two combinations of resistor and/or capacitor, wherein the parameters determined by the first combination of resistor and/or capacitor match with the 20V DC input and the parameters determined by the second combination of resistor and/or capacitor match with the 12V DC input. Then, when the 20V DC input is input, the parameter configuring module 4 controls the change-over switch to switch on the first combination of resistor and/or capacitor, thereby configuring the parameters of the DC-DC converting module 1 to match with the DC input. Similarly, when the 12V DC input is input, the parameter configuring module 4 controls the change-over switch to switch on the second combination of resistor and/or capacitor. As such, the parameters of the DC-DC converting module 1 can be configured to match with the DC input by selecting the resistance value and/or capacitance value of the parameter adjustable circuit 11 according to different DC inputs.

In other preferred embodiments, the parameter adjustable circuit can select and use other resistor-capacitor adjusting means and methods, such as an electronic potentiometer and an electronic capacitor. The parameter configuring module 4 can select a proper resistance value and/or capacitance value by adjusting the electronic potentiometer and/or electronic capacitor, so as to configure the parameters of the DC-DC converting module 1.

In an embodiment of the present invention, the parameter configuring module 4 comprises a detecting unit 41, a parameter determining unit 42 and a control unit 43. The detecting unit 41 detects a DC input received at the input terminal 2, for example, detects one or more of voltage, current and power level of the DC input. The parameter determining unit 42 determines the parameters of the DC-DC converting module 1 according to the detected DC input. For instance, the parameter determining unit 42 determines the parameters of the DC-DC converting module 1 according to one or more of the voltage, current and power level of the detected DC input. The control unit 43 controls the DC-DC converting module 1 to adjust the parameters thereof as the determined parameters. For instance, the control unit 43 configures the parameters of the DC-DC converting module 1 as a proper value by setting the resistance value and/or capacitance value of the parameter adjustable circuit 11. The control unit 43 may select a proper resistance and/or capacitance by choosing the position of the change-over switch or adjusting the electronic potentiometer and/or electronic capacitor, so as to configure the parameters of the DC-DC converting module 1 as a proper value.

Besides, though not shown, the power circuit according to embodiments of the present invention may further comprise its own power module for supplying operational power for the parameter configuring module 4.

Although embodiments of the present invention are described with a 20V DC input from an AC adapter and a 12V DC input from a battery as an example, persons skilled in the art will realize that the embodiments are also applicable to inputs of other voltage levels, current levels or power levels. Theoretically speaking, by designing a variable resistance value and/or capacitance value of the parameter adjustable circuit 11, for any DC input, the parameter configuring module 4 can determine proper parameters of the DC-DC converting module 1 according to the voltage level, current level or power level, and set the parameters by adjusting the variable resistance value and/or capacitance value of the parameter adjustable circuit 11. By designing the variable resistance value and/or capacitance value of the parameter adjustable circuit 11 in a certain proper range, the embodiments of the present invention can convert DC inputs in a corresponding range with high efficiency and low noise.

Embodiments of the present invention enable automatic detection of DC input of a power circuit and automatic configuration and adjustment of parameters of a DC-DC converting module, to implement a wide range input power circuit while keeping high performance power and ultra-low noise to obtain better image quality under a high-sensitivity mode. Embodiments of the present invention can achieve the best DC-DC conversion performance towards different inputs, which facilitates improving the performance of the portable ultrasound detecting device using the power circuit and reducing the power supply noise of the device, thereby ameliorating the issue of the power supply noise in the ultrasound detecting device under the high-sensitivity mode.

According to an embodiment of the present invention, the DC-DC converting module comprises a parameter adjustable circuit, said parameter adjustable circuit comprising a resistor with a variable resistance value and/or a capacitor with a variable capacitance value connected to the DC-DC converting module, wherein the parameter configuring module configures the parameters of the DC-DC converting module to match with the DC input received at the input terminal by adjusting the resistance value and/or capacitance value of the parameter adjustable circuit.

According to an embodiment of the present invention, the parameter configuring module comprises: a detecting unit for detecting the DC input received at the input terminal; a parameter determining unit for determining the parameters of the DC-DC converting module according to the detected DC input; and a control unit for controlling the DC-DC converting module to adjust the parameters thereof as the parameters determined by the parameter determining unit.

According to one embodiment of the present invention, the detecting unit detects one or more of voltage, current and power of the DC input; and the parameter determining unit determines the matched parameters according to said one or more of voltage, current and power.

According to an embodiment of the present invention, the DC input comes from one of a battery and an AC-DC converter.

According to an embodiment of the present invention, the DC input from the battery has a voltage of 9-12 volts and the DC input from the AC-DC converter has a voltage of about 20 volts.

According to an embodiment of the present invention, the parameter adjustable circuit uses a change-over switch and a set of resistors with different resistance values and/or a set of capacitors with different capacitance values to implement a resistor with a variable resistance value and/or a capacitor with a variable capacitance value; and the parameter configuring module selects a proper resistance value and/or capacitance value by controlling the change-over switch.

According to an embodiment of the present invention, the parameter adjustable circuit uses an electronic potentiometer and/or an electronic capacitor to implement a resistor with a variable resistance value and/or a capacitor with a variable capacitance value; and the parameter configuring module selects a proper resistance value and/or capacitance value by adjusting the electronic potentiometer and/or the electronic capacitor.

According to an embodiment of the present invention, the power circuit further comprises a power module for supplying power for the parameter configuring module.

Embodiments of the present invention improve the performance of the DC-DC converting module, reduces noise and enhances efficiency, in particular improves the reliability of the power circuit and enhances the continuous wave Doppler image quality.

The foregoing and other features and details of the present invention will become obvious with the following detailed description of various embodiments of the present invention with reference to the figures.

It shall be noted that although the block diagram of FIG. 2 illustrates the parameter configuring module as being independent of the DC-DC converting module, persons skilled in the art will realize that some or all of the units of the parameter configuring module can be integrated by means of software, hardware, firmware or a combination thereof in the DC-DC converting module as a part thereof.

It shall also be noted that although the power circuit is indicated in the above description to be used in an ultrasound detecting device, persons skilled in the art will realize that the power circuit of the present invention is also applicable to other systems, apparatuses or devices.

The foregoing is a description of embodiments of the present invention with regard to specific devices, configurations and components. However, persons skilled in the art after reading the description shall realize that certain alterations or amendments may be made to the embodiments and/or the operations thereof in the present disclosure without departing from the spirit or scope of the present invention. Therefore, a proper scope of the present invention shall be defined by the claims as attached. The various embodiments, operations, components and configurations disclosed herein are generally illustrative, rather than meant to limit the scope of the present invention.

What is claimed is:

1. A power circuit comprising:
an input terminal configured to receive a DC input;
a DC-DC converting module configured to convert the DC input received at the input terminal into one or more DC outputs at predefined ratings;
a parameter configuring module configured to configure parameters of the DC-DC converting module to match with the DC input received at the input terminal based on different DC inputs, wherein the DC-DC converting module is further configured to operate at the parameters configured by the parameter configuring module; and
an output terminal configured to output the one or more converted DC output.

2. The power circuit according to claim 1, wherein the DC-DC converting module comprises a parameter adjustable circuit, wherein the parameter adjustable circuit comprises at least one of a resistor with a variable resistance value and a capacitor with a variable capacitance value connected to the DC-DC converting module, and wherein the parameter configuring module is configured to configure the parameters of the DC-DC converting module to match the DC input received at the input terminal by adjusting at least one of the resistance value and the capacitance value of the parameter adjustable circuit.

3. The power circuit according to claim 1, wherein the parameter configuring module comprises:
a detecting unit configured to detect the DC input received at the input terminal;
a parameter determining unit configured to determine the parameters of the DC-DC converting module according to the detected DC input; and
a control unit configured to control the DC-DC converting module to adjust the parameters thereof as the parameters determined by the parameter determining unit.

4. The power circuit according to claim 3, wherein the detecting unit is configured to detect at least one of voltage, current and power of the DC input, and wherein the parameter determining unit is configured to determine the matched parameters according to the at least one of the voltage, current and power of the DC input.

5. The power circuit according to claim 1, wherein the DC input is received from at least one of a battery and an AC-DC converter.

6. The power circuit according to claim 5, wherein the DC input is received from a battery and an AC-DC converter, the DC input from the battery having a voltage of about 9 volts to about 12 volts, and the DC input from the AC-DC converter having a voltage of about 20 volts.

7. The power circuit according to claim 2, wherein the parameter adjustable circuit comprises a change-over switch and at least one of a set of resistors with different resistance values and a set of capacitors with different capacitance values, to implement at least one of the resistor with the variable resistance value and the capacitor with the variable capacitance value, and wherein the parameter configuring module is configured to select at least one of a proper resistance value and a proper capacitance value by controlling the change-over switch.

8. The power circuit according to claim 2, wherein the parameter adjustable circuit comprises at least one of an electronic potentiometer and an electronic capacitor to implement at least one of the resistor with the variable resistance value and the capacitor with the variable capacitance value, and wherein the parameter configuring module is configured to select at least one of a proper resistance value and a proper capacitance value by adjusting at least one of the electronic potentiometer and the electronic capacitor.

9. The power circuit according to claim 1, further comprising a power module configured to supply power to the parameter configuring module.

10. A portable ultrasound detecting device comprising a power circuit, the power circuit comprising:
an input terminal configured to receive a DC input;
a DC-DC converting module configured to convert the DC input received at the input terminal into one or more DC outputs at predefined ratings;
a parameter configuring module configured to configure parameters of the DC-DC converting module to match with the DC input received at the input terminal based on different DC inputs, wherein the DC-DC converting module is further configured to operate at the parameters configured by the parameter configuring module; and
an output terminal configured to output the one or more converted DC output, wherein the portable ultrasound detecting device operates with the one or more DC output from the output terminal of the power circuit.
